(19) United States
(12) Patent Application Publication
(10) Pub. No.: US 2007/0000602 A1
(43) Pub. Date: Jan. 4, 2007

(54) Paper products and processes of producing them

(76) Inventor: Clyde H. Sprague, Boulder Junction, WI (US)

Correspondence Address: DENNIS H. LAMBERT & ASSOCIATES, 7000 VIEW PARK DRIVE, BURKE, VA, 22015, US

(21) Appl. No.: 11/478,231

(22) Filed: Jun. 29, 2006

Related U.S. Application Data
(60) Provisional application No. 60/696,267, filed on Jul. 1, 2005.

(51) Int. Cl. B32B 37/00

(52) U.S. Cl. 156/272.4; 156/62.6; 428/537.5

(57) ABSTRACT

A product and process of making it, wherein small pieces or shreds of paper (12, 12a, 54) or other material are bonded together to form a panel (11, 51, L, V) or other shaped product (70, 80). The pieces or shreds of paper or other material may be randomly oriented in three-dimensions to form a sparse, light and airy core (13), or flat pieces of paper or other material may be laminated in layers to form a denser core (53). Various energy sources (33) may be used to activate or set a bonding agent used to bond the pieces or shreds together, and energy susceptors may be mixed in the bonding agent to promote induction heating when energy is applied, and/or to manipulate the pieces of paper or other material during manufacture. The core may be formed into a flat panel (11, 51, L), or into various three-dimensional shapes (70, 80). The panel is formed into a desired shape prior to activating or setting the bonding agent. Liners (15, 16, 58, 59) may be applied to the panel.

This application claims the benefit of U.S. provisional patent application Ser. No. 60/696,267, filed Jul. 1, 2005.

### TECHNICAL FIELD

This invention relates generally to structural products made from paper or other materials with similar characteristics, and to processes for producing them. In particular, according to one aspect the invention relates to a substantially planar structural product, intended in a preferred embodiment for replacement of the core or fluted medium of corrugated sheets, and to the process of producing the substantially planar product. In another aspect the invention relates to a structural product formed as a sheet with three-dimensional shapes, and to a process for making the three-dimensional product.

### BACKGROUND ART

Structural products made from paper or other similar material are widely used, as in corrugated shipping containers or boxes, for example. The corrugated material used in the construction of these containers is based on three or more layers of paperboard laminated together to produce a corrugated sandwich wherein the center layer, or medium, is fluted and sheets of paper, or liners, are glued to the flute tips on both sides of the medium. The medium serves to separate the liners, which produce product stiffness.

Containers intended to be stacked on top of one another during use, i.e., compression boxes, are normally valued according to the Box Compression Test (BCT) value or the Edge Compression Test (ECT) value, used as a surrogate for BCT.

Since the institution of Alternate Rule 41 (a product specification rule from transportation industries), allowing the specification of boxes in terms of the Edge Crush Test (ECT) value of the corrugated structure, about 40-50% of corrugated containers are manufactured and sold according to this specification, i.e. on how well they resist loads imposed top-to-bottom on the container.

In conventionally corrugated materials the flutes of the corrugations are generally sinusoidally shaped. The caliper of the fluted core material or medium is limited by damage imposed during the fluting process. This, in turn, limits the strength that can be incorporated in the fluted medium, i.e. the core of the corrugated structure. Furthermore, because of the flute shape normally used the liners make essentially only line contact where they are bonded to the tips of the flutes. This minimally bonded area between the fluted medium and the liners results in low strength and large unsupported areas of the liner, which can produce a wavy or uneven surface, making it difficult to print graphics on the surface of the liner.

Moreover, with conventional corrugated medium, box blanks are always cut so the flutes run vertically in the box to take advantage of the extra core strength in this direction. Unfortunately, this requires that the machine cross direction (CD) of the liners also be oriented in the vertical direction. Since the liner CD strength is only about half the machine direction (MD) strength, this liner orientation reduces the potential box strength by a significant amount. Collectively, core properties limited by fluting inflicted damage and the adverse orientation of the liner leads to an overall structure that is very inefficient in the use of fiber and, therefore, more costly than necessary.

The core is an important component of a corrugated structure. Needed is a core structure that provides better liner support, uses less expensive materials, and allows greater core caliper and overall core thickness so more material and more strength can be incorporated in the core. Also needed is a manufacturing method that does not degrade the materials from which the core is made. Commonly, when more strength is needed, two or more corrugated structures are laminated together to make a thicker and, therefore, stronger product. Much additional machinery is required to make these structures and they still use material inefficiently, with the intermediate liners being expensive and necessary, but of little value to the end structure. One attempt at making a thicker core without intermediate liners is the so-called x-flute, as described in U.S. Pat. No. 4,886,563, where two fluted mediums are glued together at the flute tips to form a thicker structure without an intermediate liner. This is a very delicate and difficult manufacturing operation, and still lacks many of the desired properties. It has not seen significant penetration in the marketplace.

Hence, a paper product and process of making it that address all of these issues is needed to fulfill the compression box market. If such a system can also meet or exceed current burst requirements of so-called containment boxes, it will be able to fulfill virtually all of the market needs.

### DISCLOSURE OF THE INVENTION

The present invention comprises rigid, unitary panels or webs made from bonded together pieces of paper that are randomly oriented in either three-dimensions or two-dimensions and that have superior strength characteristics and/or manufacturing economies as compared to conventional materials, and that are preferably lightweight, including:

A. A relatively low density, preferably, as for example, a density preferably less than about 0.1 gms/cc, and preferably an open, planar panel or web structure formed from pieces of paper randomly oriented in three-dimensions and bonded together at crossing points to form a light and “airy” structure, referred to herein as “shred-core”, with substantially equal properties in all directions in the plane and high stiffness in the z- or thickness direction.

B. A relatively higher density web formed of pieces of paper randomly oriented in two-dimensions, from which a three-dimensional panel can be formed and then laminated, called “lami-core”, including a panel with flute-like grooves that can be oriented in either the machine direction (MD) or the cross direction (CD), or any orientation between the machine direction (MD) and the cross direction (CD).

C. A lami-core structure as in “B” above, but with both MD and CD elements to give more balanced properties in the plane of the panel. Truss board as shown in FIG. 13 attached hereto is an example of such a structure.

D. Discrete, three-dimensional products with the basic open structure of A or the laminated structure of B or C.

The invention also relates to processes for making the panels or webs of this invention.

Any of these core structures will be much less costly than the conventional fluted core. All can be produced with high strength and stiffness and combined with one or two conventional liners to give advantageous properties, such as:

A. With balanced properties in the plane of the core, “shred-core” box blanks can be cut to load either the CD or the MD of the liner. When the CD is loaded, the resulting board or box will be superior to conventional corrugated material in one or more ways, e.g., ECT, flexural stiffness (FS), BCT, flat crush, creep, and resistance to structural damage during converting and case making. When the MD is used, much better ECT and BCT, flat crush and resistance to converting damage will result, but FS and box end-to-end (ETE) and side-to-side compressive (STS) strength may be reduced or unbalanced. The CD-based structure will have better overall balance among the properties. Further, when the CD is used, much of the in-place machinery and infrastructure may be utilized in the manufacture of the board, whereas some changes may have to be made when the MD is used.

B. With a CD “lami-core” structure, the CD of the liner will be loaded. This may give superior values to all of the desired board and box values and, at the same time, will give good balance among these properties. As noted, in some cases this can enable most of the in-place conventional machinery and infrastructure to be used in the manufacture of the board. At the present time, this is the preferred embodiment.

C. With a MD “lami-core”, the MD of the liner will be loaded in the box. This will give superior ECT, BCT, flat crush, and z-direction stiffness. FS, ETE, STS and creep resistance may be reduced somewhat by this structure, and at least some of the in-place machinery and infrastructure used in the production of product may have to be changed.

D. A mixed CD/MD “lami-core” will have properties intermediate the MD and CD products, and will permit loading the liner in either the MD or the CD direction to produce intermediate properties. As before, using the liner CD will enable the retention of existing infrastructure.

Especially in paper products, the invention permits constructions using liner to core combinations of CD/CD, CD/MD, MD/MD, and MD/CD. Conventional constructions allow only the CD/CD combination.

Further, although in a preferred embodiment the product made in accordance with the invention comprises a paper product made with pieces or shreds of paper, starting materials other than paper can be utilized in practicing the invention. For example, pieces or shreds of plastic material can be utilized in forming products made from plastic. The pieces or shreds of plastic can be bonded by use of an adhesive, or they could be bonded or fused together by ultrasonic welding or other methods known in the art.

With any of the foregoing structures, the properties of the core can be controlled to obtain one or more of the following advantageous properties in the board or box:

A. With shred-core, the density, thickness, chip size and bonding can be adjusted to give desired properties.

B. With lami-core, the wavelength and wave height of the flutes or corrugations, and core caliper can be selected to produce the desired properties. The angle of the flute legs will be set by choosing the length and height of the flutes.

Randomly orienting the paper pieces in the plane of the panel will give a substantially increased CD strength that can be, for example, at least about 40% higher than the CD strength of the material that comprises the core. Orientation of the pieces of paper can be varied, with the pieces either all oriented in the same direction in the plane of the panel or in different (e.g., random) directions in the plane of the panel to get different results. A random orientation would produce comparable CD and MD properties, but with greater CD strength than the CD strength of the material from which the core is made.

C. An optimized core structure combined with conventional liners will give many if not most properties that are superior to conventional corrugated material. Accordingly, lighter or lower strength liners can be combined with a stronger but less expensive core to save substantial cost and still give properties equal to or superior to corrugated, as desired.

D. To save still more cost, the liner that is normally on the inside of the box can be replaced with a thin, planar sheet created by bonding together a number of layers of paper similar to or the same as those used in the manufacture of the core according to the invention.

Any of the glue types, delivery methods, and bond-inducing means described herein may be used to produce any of the foregoing structures. Some adhesives require the inclusion of susceptors, while others, some of which are identified hereinafter, are naturally susceptible to energy sources for inducing bonding.

A CD lami-core with flute-like structures having flat wave or flute tops bonded to the liners provides more liner support, reinforces the liners in MD bending, and results in a higher core CD area moment of inertia to produce more CD bending stiffness.

Because all cores according to the invention are formed from small pieces of paper that are bonded together after forming to create a rigid structure, there are no significant stresses induced in the pieces during forming. This avoids or reduces any damage to these pieces during the manufacturing process. In conventional fluting of medium, the MD and CD properties are substantially reduced during the fluting process.

The tips (male members) of the forming dies or rolls used to form the flutes in product made with the invention can be relatively soft in relation to the opposed member of the forming die, e.g., be covered with an elastomeric material, to compensate for variations in density, for example, across the panel, whereby the tips of the formed flutes in the product are smooth and uniform.

Further, panels made in accordance with the invention can be made much thicker than conventional corrugated panels due to the ability to form pieces without causing damage. In conventional corrugated material, the panel thickness is limited because of damage that occurs during forming. Since conventional pieces must be relatively thin, stiffness and strength in the Z direction are both limited. As a result, double and triple wall constructions, i.e. two or three fluted mediums with interposed liners, are commonly used to achieve a desired strength. With the invention, the panel can be made as thick as needed, thereby eliminating the need for double and triple wall constructions.

Additionally, some applications require a very smooth surface for applying high quality printing and/or graphics. This requires the use of expensive liners and/or coatings. The present invention enables the use of a thin high quality liner laminated to a flat panel liner made in accordance with the invention to achieve a very smooth surface without the need for using a thicker liner made completely of more expensive material, thus substantially reducing the cost of providing liners having a smooth surface.

1. Flat Panel:

According to a first aspect of the invention, a new product and process of making it serve as a direct replacement for fluted corrugated sheets in most applications, including corrugated shipping containers that are currently made from corrugated sheets. This new product is a substantially flat web or panel that does not use a corrugated medium as in conventional corrugated materials. The panel comprises a sparse matrix of dry “chips” or shreds of recovered paper randomly oriented in three directions and bonded together at crossing points by a suitable adhesive to form an “airy” core of predetermined thickness, referred to herein as “shred-core”. One or more liners may be bonded to the core. Boxes and other structures made from this new product will have performance characteristics comparable or superior to corrugated materials, as determined by Box Compression Test (BCT) value or the Edge Compression Test (ECT) value, as in Alternate Rule 41, preferably at less cost, as for example, 20%, preferably 30%, and more preferably 30 to 60% less costly, and will be manufactured using much less equipment and infrastructure. The new product will also make possible the use of lower grades of recovered paper in the core, thus expanding the useable supply and reducing solid waste disposal. The new product will be virtually indistinguishable from current corrugated except for a much lower cost.

To produce the new product, recovered paper, either low-cost mixed waste or old corrugated containers (OCC), is shredded to form small pieces or “shreds” of paper (e.g., length of 10 mm-25 mm and width of 1 mm-10 mm) that are then bonded together to form a panel. Almost any recovered paper can be used for the “shreds”, including, but not limited to, old corrugated, magazine, wax coated paperboard, waste printing, writing, and publication and the like. The shreds will be randomly oriented in all three directions, or any desired direction, with lots of air space, and will be bonded together at crossing points to produce an “airy” core of desired thickness. The resulting flat web or panel, especially when liners are applied to both surfaces, can be used in lieu of traditional corrugated, and can be made in any thickness and converted into a box using conventional equipment. Because of the construction of the core in the present invention, i.e., with preferably randomly oriented pieces of paper bonded together at crossing points, the strength of a finished product made from the core is not dependent upon whether the boxes are cut so the liners are loaded in the machine direction or the cross direction. Boxes made with the new product are expected to be equivalent or superior to the corrugated boxes they are intended to replace in all characteristics important to the corrugated market place. Hence, the new product can be marketed as a direct replacement product.

A foamed adhesive or filler combined with the paper shreds may also be used to form the sparse matrix in the flat panel of the invention. Further, starting materials other than paper can be used in practicing the invention.

A. Process Using Heat-Sealing Coatings:

According to a first process, the paper shreds are bonded together using heat-sealing coatings. In this system, the shreds are dispersed in a levitated state in a levitation chamber and “coated” with a non-blocking, recyclable, water-based heat-sealing coating and dried while still levitated, or coated with some other material and/or dried in some other way. Preferably, the coating material contains a dispersion of very small magnetic particles or other susceptors for other energy sources. Alternatively, other materials could be used that are naturally or inherently susceptible to bonding inducement by various energy sources, such as, for example, cellulose acetate, butyrate, ethyl vinyl acetate, and polyvinyl chloride. U.S. Pat. No. 6,600,142 discloses useful adhesives, and its disclosure is incorporated herein. Once the applied adhesive is dried, the shreds can be stored for later use. The new paperboard product is then dry-formed to a desired thickness by depositing a layer of the dry coated shreds on a bottom liner. A second liner is then added on top of the deposited layer. This sandwich then passes through a nip to set the desired thickness and thence between belts or air bearings to hold the thickness. Suitable energy applied in the compression section heats the coatings to the bonding point. When magnetic particles are dispersed in the coating material, inductive energy is used, and all of the induction heating will be concentrated in the adhesive so there will be very little heating of the paper shreds or liners. By appropriate selection of the magnetic susceptors or particles, the Curie Point or Curie Temperature, Tc, can be selected so that induction heating is limited to a maximum temperature that will activate or set the bonding agent but not damage the panel, effectively making the induction temperature self-regulating to a safe level. That is, once the Curie Temperature is reached, no further induction heating will occur. Further, magnetic or static electric energy can be used to manipulate the pieces during formation of the product.

Similarly, when microwave or other radio frequency (RF) susceptors are dispersed in the coating material, and microwave or other RF energy is used to heat the adhesive, most or all of the heat goes to the adhesive. Consequently, the largely unheated paper components act as heat sinks to cause the hot coatings to cool quickly to form fiber-tearing bonds in the matrix.

Further, compressing the panel to a desired caliper can be accomplished by using a belt having means embodied therein for inducing a strong magnetic field to attract the particles embedded in the panel, thus compressing the panel without the need for mechanically pressing it, which normally is difficult to accomplish using belts.

By using the processes according to the invention, the resulting board or panel will be cool and dry when it leaves the machine, as opposed to hot and moist in conventional processes. Hence, the board is warp-free, and it can be converted immediately with little or no loss of performance. The manufacturing system of the invention could be small and operate at room temperature.

B. Process Using Water-Based or Hot Melt Adhesive:

In a second process, a water-based adhesive is used, such as, e.g., Stein-Hall starch, PVA, etc. or a hot melt adhesive is used. A thin layer of adhesive is first applied to a bottom liner, and a thin layer of dry, uncoated paper shreds is then laid down on the adhesive-coated liner. A thin layer of adhesive is applied on top of the layer of shreds, followed by a second layer of shreds to which a further layer of adhesive is applied, and so on, until a core of desired thickness is achieved. The adhesive preferably contains a dispersion of very small magnetic or other susceptor particles that can be heated by induction or other remote energy sources. After the last layer of adhesive is added, a top liner is applied. The sandwich then passes between rollers with a fixed gap to set the caliper of the final structure. A final section holds the caliper and applies induction or another form of energy to “set” the adhesive to form a rigid panel structure. With water-based adhesives it will be necessary to “dry” the resulting panel to form a final product. This process is more energy intensive than the process using pre-dried heat-sealing coatings, but enables the use of less costly adhesives. One starch-based material, disclosed in U.S. Pat. Nos. 5,609,711 or 5,895,545, for example, may be used as an alternate bonding agent that has the potential to behave like hot-melt materials, but would not require drying in the induction section. Typical hot-melt adhesives laden with susceptor particles may also be used, and hot melts that can be sprayed are also possible, including “Glu Guru”®, SP630, a general purpose sprayable hot melt available from Manufacturer's Supply Co., U1125.

Successful induction-induced bonding has been demonstrated in many other much higher technology applications, including the field patching of armor in military vehicles. Much research in this field in recent years has served to clearly define the requirements of such systems and their great success. The beauty of the process is in delivering the heat exactly where it is needed, in not heating the water or fiber in the boards, and in almost instantaneous heat generation, so the process can be fast and the equipment small. This method of inducing bonding has been tried in crudely assembled samples of linerboard, using an iron particle-laden (about 5%, by volume) heat-sealing coating as the binder. Temperature increases of 200° F. were achieved in 5 seconds using very crude and non-optimized equipment. Fiber-tearing bonds resulted. These systems are very dependent on optimizing the particle size and dispersion and the type of inductive field used. Bond inducement at distances up to 1″ from the lower surface appear quite feasible, so sheets or panels up to this thickness could be produced on a single machine. Similarly, RF heating of suitable susceptors can be used to induce bonding.

For either manufacturing approach, the resulting stiff web of material could then be slit and cut into sheets, and the same equipment could be used that is used for conventional corrugated material. Since the core of the invention has in-plane properties equal in both directions (i.e., the “x” and “y” directions), the sheet long dimension can be cut in either direction rather than just the machine direction, as required with corrugated material. Cutting the blank long dimension across the machine allows loading the liner in its MD, giving much greater strength, or allowing the use of correspondingly lighter liners or less costly or lower strength liners. Using the MD of the liner will influence the panel machine width and paper machine trim. For blanks in the cross direction, a machine sized to be two sheets wide should work well with the many paper machines to avoid trim losses. The term “liner” as used herein is intended to include any material that will be adhered to the top of a core.

There are many components to the most preferred manufacturing system of this invention used to produce the flat panel according to the most preferred first aspect of the invention, including one or more of the following:

1. A shredding.system to convert the recovered paper into “shreds” with a suitable size distribution and shape, as distinguished from conventional processes of defibering and then using the fibers in a dilute slurry, or using paper that has been hammer-milled to form dry fibers (and dust).

2. A layering system to distribute the “shreds” over the bottom liner in one or more thin, uniform layers or a single layer of required thickness, depending on the adhesive system used.

3. An adhesive application system to provide the desired distribution, preferably a fine and/or uniform distribution of adhesive over the shreds or between the layers.

4. An ingredient in the adhesive that is susceptible to heating induced by various remote energy sources, or an adhesive that is naturally or inherently susceptible, so the adhesive can be set without heating or drying the paper.

5. An induction or other system for delivering energy directly to the adhesive for fast, efficient bonding. This system must maintain the caliper of the sandwich until the bonding is sufficiently complete to maintain rigidity. This technology is already well developed and a number of companies could supply the hardware. Efficiencies would be quite high because only the adhesive need be heated.

6. Conventional converting equipment to convert sheets into boxes.

The intent of this technology is to provide a product that is equal or superior to the properties of the corrugated it replaces, with respect to one or more of its strength properties, without dependence upon whether the boxes are cut to load the liners in the machine direction (MD) or the cross direction (CD).

A box produces top-to-bottom compressive strength (BCT) as a function of two board properties; the edge crush test (ECT) value measured parallel to the flutes in corrugated that corresponds to the vertical direction on the box, and the flexural stiffness (FS) of the box panels, taken as the geometric mean of the values measured in the CD and MD directions.

A most preferred product produced in accordance with the invention is expected to have the following advantages:

1. Lower cost.

2. Because the core is expected to have significant compressive strength, the resulting ECT values will be much larger than those for corrugated made from comparable liners. How much larger depends on which direction of the liner is loaded, i.e. whether the box blanks is cut in the CD or the MD. Hence, the new product will be able to produce the same ECT with liners using less fiber and/or lower cost fiber. Cutting the box blank in the MD eliminates the necessity of taking the extraordinary steps now used to “square” linerboard machines, i.e. shift MD strength to the CD.

3. Flexural strength (FS) will be reduced by the lighter liners and increased somewhat by the stiffer core. Since stiffness varies as the square of liner separation, small increases in core thickness will make up any remaining deficit and restore FS to the value for corrugated.

4. Given the ECT and FS projected in 2 and 3, the BCT (box compression test) values will be substantially the same as for comparable corrugated.

5. If the core is effective in producing burst strength, as expected, then burst, puncture resistance, and tare weight should be equal to those for corrugated, with a slightly higher caliper.

6. Superior z-direction stiffness and flat crush, post-printability, creep resistance, humidity resistance, scoring, and less warp are all possibilities. In conventional corrugated, damage to the flutes imposed by feed nips, printing cylinders, etc. often substantially reduces compressive strength of the box. The present invention should eliminate or substantially reduce this loss, giving another significant advantage over corrugated. Assembled dry, the new most preferred product will have less warp than corrugated, leading to fewer problems in converting and case packing.

2. Three-Dimensional Panel:

According to a second aspect of the invention, a three-dimensional product and process of making it can also serve to replace conventional fluted medium, or to produce other three-dimensional objects of desired configuration. For example, the new panel can be formed with parallel grooves to produce a new corrugated panel in which the grooves can be oriented either parallel or perpendicular to the machine direction, or some combination of CD and MD. While the parallel orientation may be more difficult to manufacture it will provide superior performance in some aspects of the finished product. All orientations are intended to be covered by this invention. Other three-dimensional shapes can also be produced in accordance with the invention. For example, trussboard, egg cartons, and other shapes can be made economically and with a rigid structure.

The new three-dimensional product combines some of the concepts of the first aspect of the invention, i.e. the use of bonded-together pieces of recovered paper or other material to make a panel core, with the use of three-dimensional forming dies to make three-dimensional objects of many shapes. In contrast to the sparse matrix of the first-described form of the invention, the core in the three-dimensional product has a regular, well-defined geometry containing a large volume of open space and a small volume of the bonded-together paper structure that, in this case, is quite dense.

To produce the new three-dimensional product, a web comprised of layers of pre-glued pieces of paper can be produced in many ways. The three-dimensional product can then be formed from the web with a belt press, or a corrugating roll, or laid down on one half of a die and formed by pressing with the other half, or any device that imparts the desired shape. After forming, the bonds can be set by applying the appropriate form of energy, as in the first-described aspect of the invention, to form a rigid object of desired three-dimensional shape. A core comprised of layers of adhesively bonded pieces of paper is referred to herein as “lami-core”. Objects produced from lami-core will be strong, inexpensive, and easy to make, and in applications to replace corrugated, will diminish the requirements for liner.

Similarly to the first-described form of the invention, the pieces of paper are obtained by passing recovered paper of almost any sort, but with lightweight, currently unused paper being preferred, through a simple separation in the dry state to remove large metallic or plastic inclusions. Using mechanical equipment and operating in the dry state the paper is “sliced” or comminuted to produce pieces or “chips” of paper. For example, fairly large (preferably 50-100 mm) flat pieces can be obtained and used to produce the desired results.

The pieces can be passed through an air levitation chamber, or a drum mixer, or other like apparatus, to suspend them at low concentration, and a suitable adhesive in aerosol, encapsulated, or small particle form introduced into the chamber or mixer to apply a desired amount of adhesive to all or some of the pieces. Alternatively, the pieces and adhesive could be mixed in the shredder. Examples of adhesives or bonding agents could include wax, starch, hot melts, or other materials that can be activated by microwaves or other radio frequency waves, or other sources of energy, including infrared, electron-beam, etc. Adhesives that are naturally or inherently susceptible to the source of energy are included. Using an adhesive that is introduced in an inactive state is preferred. One possibility is a heat-sealing adhesive sprayed on the paper “chips” and dried in the levitated state. Further, in a preferred embodiment magnetic particles or other energy susceptors are interspersed in the adhesive. These particles or susceptors can then be activated with induction or other forms of energy, respectively, in the combining section to form the required bonds.

As the mixture passes out of the mixing chamber it is formed into a continuous, un-bonded or loosely bonded web with a thickness of a few overlapping loose pieces, for example 2-10 layers. Still in this “loose” state the “web” is placed between a pair of plates or rollers or belts or other forming means. Each plate or roller or other forming means has a desired shape to produce the desired article configuration, e.g., a grooved shape, trussboard, egg cartons, etc. As the “web” is compressed between these elements the pieces slide over each other to conform to the shape of the plates or rollers, but with the entire area covered more or less uniformly by a few layers of the paper pieces. When the desired form is achieved, energy is applied to activate the adhesive between the strips to bond them together and form a rigid, laminated structure that has and will retain the shape of the plates or rollers. If a grooved web is being produced, the plates or rollers can be arranged so the grooves run in either the machine direction, i.e. along the machine, or in the cross direction, i.e., perpendicular to the machine direction.

Alternatively, starting sheets of paper may be mechanically cleaned, as above, then partially cut or slit to form interconnected segments of a size equal to the desired size of the pieces. The segments are connected to one another by small connections that remain intact until the forming process. These large sheets of partially slit paper are then passed through an adhesive application process, for example a pair of gravure rollers, to apply adhesive over only a fraction of the total surface area. This adhesive may be “cured” and then reactivated after forming, or applied just before the forming process and “cured” after forming. Substantially less adhesive and, therefore, less adhesive curing energy are required with this approach, which also facilitates processing by preserving the original, larger dimensions of the starting sheet. Adjacent bonded areas should be spaced so the slenderness ratio of the paper interposed between bonds assures failure in compression rather than in buckling. During the forming process, the connections are broken to free each segment or piece so that it can slide over an adjacent piece. For reasonable starting materials, satisfactory results may be achieved with application of adhesive to as little as 10% of the total area. Partial slitting and partial glue application further reduce cost by reducing the amount of adhesive required, and the energy required to “slit” the paper and set the bonds. In this regard, application of adhesive to only a portion of the surface area of the pieces is equally applicable whether the pieces are precut or semi-slit.

If the three-dimensional panel is a fluted or corrugated structure, it is desirable to have flat smooth caps on the flutes to promote bonding to the liners and to minimize interference with post-processes such as printing. However, given the nature of the core structure, these caps may have a varying number of layers of materials with varying thickness. To increase sidewall compression and/or to accommodate this thickness variation in the caps, the tips of the flutes on one forming member are preferably elastic, whereas the groove bottoms of the opposite forming member are preferably hard to hold flatness and overall core thickness.

In a second step, as when producing a grooved web, for example, continuing support is provided on only one side of the web by one of the plates or rollers, and a liner is then brought in contact with the unsupported side of the grooved web and bonded in place. Bonding may be achieved by conventional means using starch adhesives, as in conventional corrugating, or by using the heat-sealing material still present on the exposed tips of the grooved structure. A second liner may be added in a conventional or other manner. The resulting product is visually similar to conventional corrugated but has several critical structural differences, as follows:

1. The core will give the inherently higher stiffness and strength of a laminated structure, further improving the performance of the core and, therefore, of a box made from the structure. Because the forming process of this invention does not damage the materials from which the core is constructed the core can be formed to any caliper and any reasonable thickness. Consequently, much of the required structural performance of the box can be built into the core using inexpensive materials and thus reducing the liner requirement and cost.

2. The sidewalls of the grooves can be straight with a fairly steep angle with respect to the attached liners, leading to a much higher z-direction stiffness and crush resistance than for a conventional fluted shape. This improved geometry, plus the extra strength incorporated in the core, will reduce the damage that normally occurs in the ensuing converting operations, so costly in conventional corrugating.

3. The flat tops of the grooved structure will reinforce the liner to increase bending stiffness and, at the same time, provide much more support for the liners to reduce liner buckling between the ridges, a factor that will further improve performance, especially with respect to accelerated creep in cycling humidity environments, typical of the distribution system in which boxes are used.

4. The grooves may be oriented in either direction, and the box blanks cut in either direction, thus giving four options of how the box is constructed. All options can give superior BCT values thus reducing the requirement for liner fiber and, correspondingly, reducing liner cost. Boxes cut to load the MD of the liner take advantage of the higher strength in the MD, for example nearly 2 to 1 compared with the CD. However, for balance among all box properties and minimum disruption of the existing infrastructure, CD flutes and CD loading of the liners represent the preferred embodiment of this invention.

5. The pieces of paper from which the core will be made may be randomly oriented in the plane of the core, whereby the properties in both directions are the average of the normal CD and MD properties of the base material. However, the CD strength is greater than in conventional fluted medium. This means that for the same flute orientation, the CD of the fluted structure of the invention can be much stronger than the CD of conventional fluted medium.

Potential advantages of the new structure and/or process include, but are not limited to, one or more of the following:

1. The combination of core shape, caliper, thickness and lamination will give much more z-direction stiffness and crush resistance to reduce converting damage and consequent loss of BCT. For example, the loss of BCT due to crushing of the current core in converting operations, for example between 15-50%, will be reduced or substantially eliminated.

2. Increased z-direction support on the liner instead of the narrow peaks and valleys of a fluted core for better post-printability and greater box strength. For example strength in the z-direction can be increased as much as about 25%, although in some instances the increase in strength may be less.

3. A much larger fraction of total board strength can be built into the core to obtain significantly greater BCT values or reduce liner requirements.

4. The new core may contribute to a better containment box, as well.

The process could offer several avenues to improve the efficiency of the box construction process, including possibly reducing one or more of the following: capital costs, manufacturing costs and raw material costs.

1. Capital costs could be reduced by several methods. For example: the potential to use recovered paper and/or other recovered materials reduces the amount of medium that must be produced, reducing the capital required for the paper mill system that feeds the box plants; the ability to shift the load-carrying capacity to the core may enable reductions in the basis weight of the liners needed to construct a box with a given compression performance specification, which could reduce the number of paper machines needed to supply the box plants with liner; the new process for making the panels could contain fewer components than the current corrugation process, for example, single-facers, reducing the capital cost at the box plant. In some embodiments, much of the in-place equipment in the box plants can be retained and used, which would avoid additional capital costs to implement the process

2. Manufacturing costs could be reduced due to several features of the invention. For example: manufacturing costs at the paper mills would be less due to the need to produce less paper to make a given number of boxes of given dimensions, which reduces costs for fiber and energy needed to form paper from that fiber; a process to produce the panels that operates at ambient temperature would substantially reduce the energy consumption at the corrugator; combined board produced at or near ambient temperature could be converted into boxes immediately, whereas the current process requires waiting for many hours, typically 24 hours, to obtain a box with the highest compression strength and the lowest converting losses in the downstream process; board produced at ambient temperature could be much less prone to warp, a leading cause of yield loss (amount of paper coming into the box plant that does not go into a box that is sold) at the box plant; reduce yield loss could also translate into lower reject disposal costs.

3. Raw material costs could be reduced. For example: The recovered paper is less costly than the products currently used to form the core; the waste material from the box plant can be recycled directly, resulting in reducing or eliminating the yield loss; the freight charges would be reduced because, in most instances, the box plants are closer to the sources of recovered fiber or other recovered materials than they are to the paper mills; for some applications the core may provide an adequate inner surface, thus eliminating one liner, and liner basis weight can be reduced for a box of a given performance, thus reducing the weight of liner that must be shipped to the box plants and therefore reducing the freight costs per box; and, the demand for infusion of new “box” fiber, i.e. demand on the wood basket, will be reduced, which could moderate or reduce fiber prices.

4. The invention allows production of board with greater flexibility in the orientation of the fluting and direction of highest web strength (typically the machine direction (MD) for paper machines today) than with the current process. So the fluting, which is the direction of loading, can be aligned with either the MD or CD (cross machine direction), or some intermediate angle. This has many potential advantages, including examples such as: Orienting the fluting in the MD of the corrugator would allow boxes to be made with the compression direction aligned with the MD of the liner, which is normally stronger than the CD. Box strength could be substantially increased at the same fiber content, or fiber weight could be reduced at the same performance. This may be enabled by exchanging the slitter/scorer and cutoff knife directions, which would also allow the boxes to be cut from the blanks in the opposite direction from current practice. That may have additional advantages, since it may create greater optimization of the utilization of the combined board for some box designs. In some embodiments, MD fluting could also reduce the desire to run “square” liner machines, allowing improved utilization of the papermachine's inherent tensile orientation.

The process will also fit well with the sheet-feeder concept, i.e. one high production sheet plant feeding many converting plants. Further, since the blanks will run across the machine, i.e. in the liner machine direction rather than the cross direction, as now required, the edge compression (ECT) and box compression (BCT) values should further increase. Contributions to ECT from use of a slightly thicker core will compensate for the bending stiffness loss due to the use of lighter liners, and could give equal BCT with about half the liner thickness currently used.

Adhesive costs may be higher than the current cost of starch for corrugating, and tare weights might be slightly higher, depending on the final weight of liner(s) required. Product produced in accordance with the invention could be recycled back into conventional processes. Because of the high z-direction strength and stiffness of the laminated core its thickness may be substantially increased without running the risk of damaging the box blanks in converting. Such thick products may be able to replace conventional double or triple wall corrugated with a single wall structure. This will be a much simpler manufacturing process and a less costly product. Alternatively, multiple layers of the corrugated material could be laminated or stacked together, preferably with the flutes of one layer extending perpendicular to the flutes of an adjacent layer, to produce double wall, triple wall or other combinations of superior strength.

The use of cores or panels made in accordance with the invention enables four different construction options to be used, wherein liners may be applied in any of the following combinations of liner orientation to core orientation: CD/CD; CD/MD; MD/MD and MD/CD, where CD is machine cross direction and MD is machine direction. This flexibility is offered by no conventional construction.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a top perspective view of a flat web or panel according to the invention.

FIG. 2 is a schematic view illustrating one process system for forming the flat, non-corrugated product according to the invention.

FIG. 3 is a schematic side view of a flat web or panel in accordance with the invention, depicting the random, three-dimensional orientation of the pieces of paper, or “shreds”.

FIG. 4 is a schematic top view of the web or panel of FIG. 3, with liners applied to both faces and a portion of one of the liners broken away to show the sparse core of paper shreds.

FIG. 5 is a schematic block flow diagram depicting the steps in a process for forming the pieces of paper.

FIG. 6 is a schematic view illustrating an alternate process system for forming the flat, non-corrugated product according to the invention.

FIG. 7 is a top perspective view of one example of a three-dimensional web or panel according to the invention.

FIG. 8 is a schematic transverse sectional view of an unbonded three-dimensional web or panel formed of layered flat pieces of paper in accordance with another embodiment of the invention, showing the overlapping relationship of the flat pieces of paper, before the web is formed into a three-dimensional shape, and before liners are applied.

FIG. 9 is a fragmentary schematic top plan view of the web or panel of FIG. 8, with portions broken away for simplicity of illustration.

FIG. 10 is an exploded perspective view of a pair of core-forming dies for producing a web or panel having elongate parallel grooves.

FIG. 11 is a schematic side view of the dies of FIG. 10, with a web or panel formed of layers of paper chips disposed therebetween preparatory to being compressed into a corrugated shape.

FIG. 11a is a plan view of a sheet of paper partially slit into smaller segments connected by attachment points that are broken during forming to produce the pieces of paper used in the invention.

FIG. 12 is a schematic side view of a web or panel produced with the dies of FIGS. 10 and 11, with liners applied.

FIG. 13 is a perspective view of an example of a trussboard that can be produced in accordance with the invention.

FIG. 14 is a perspective view of an example of an egg carton that can be produced in accordance with the invention.

FIG. 15 is a somewhat schematic transverse sectional view of a portion of a panel produced using the “shred core” embodiment in accordance with the invention, showing the three-dimensional random orientation of the pieces of paper and bonding of them at crossing points.

FIG. 16 is a view similar to FIG. 15, but showing an arrangement of platens to control thickness, and induction coils that may be used in the production of the panel of FIG. 15.

FIG. 17 is a schematic side view, shown greatly enlarged, of a liner that can be produced in accordance with the invention.

FIG. 18 is a schematic side view of a liner produced in accordance with the invention laminated with a thin conventional liner.

### DETAOLED DESCRIPTION OF THE PREFERRED EMBODIMENTS

1. Flat, Non-Corrugated Board:

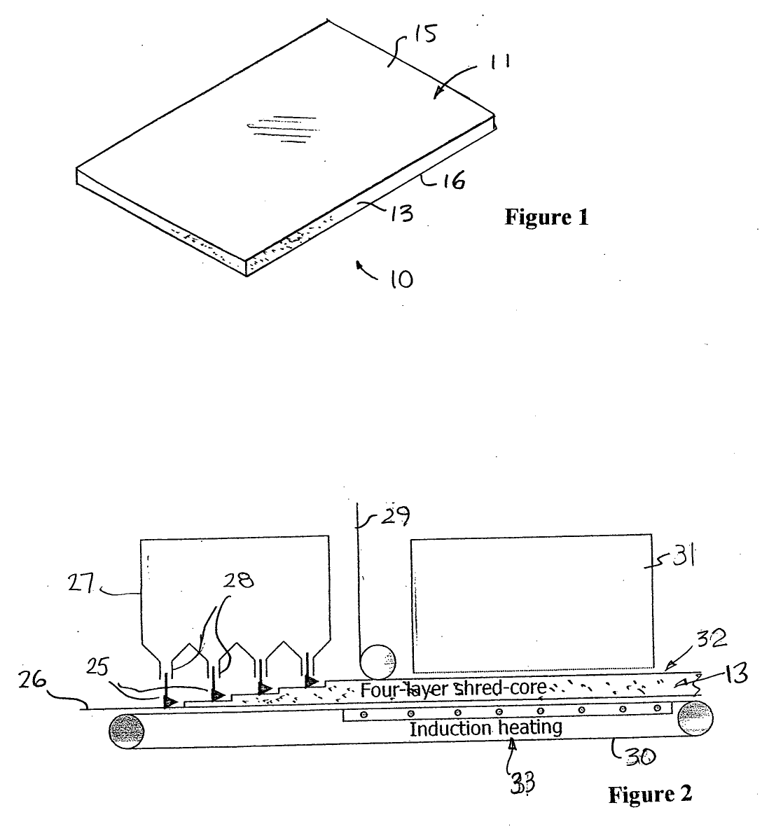

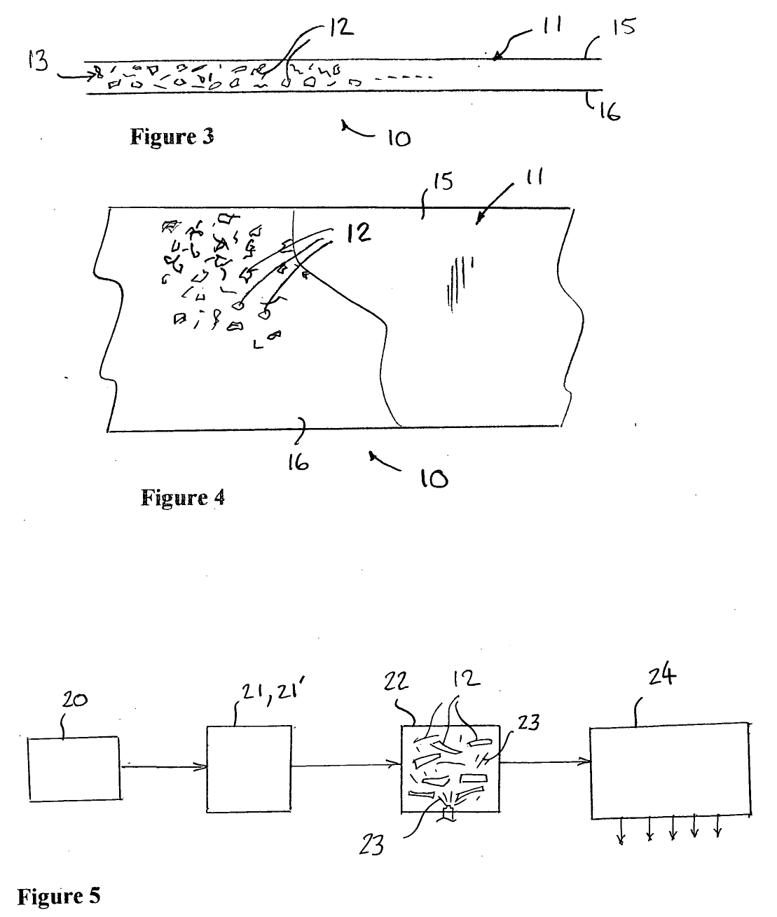

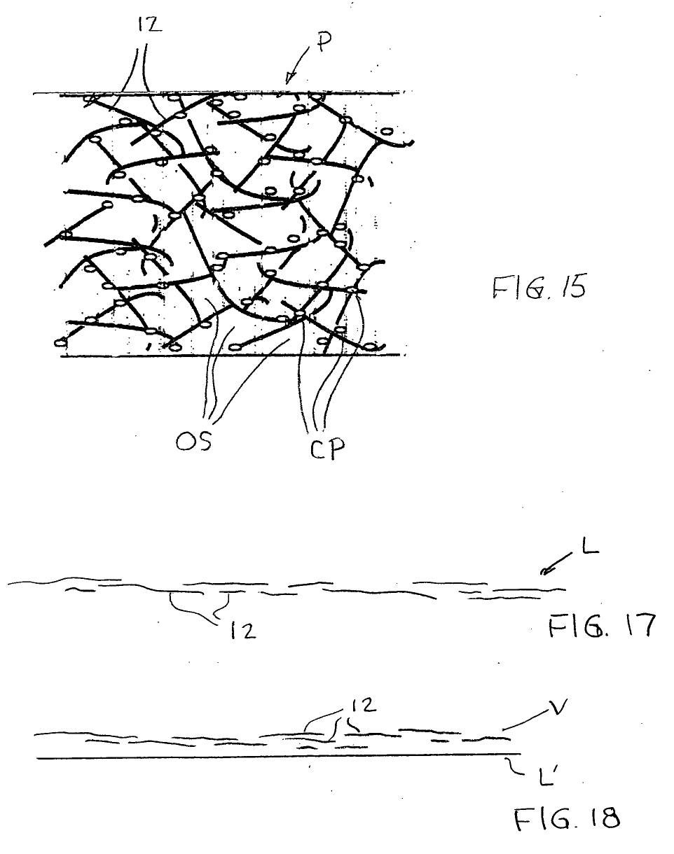

A paper product made in accordance with a first aspect of the invention, indicated generally at 10 in FIGS. 1, 3, and 4, comprises a flat, non-corrugated web or panel 11 formed from paper pieces or shreds 12 randomly oriented in three-dimensions and adhesively bonded together at crossing points CP (see FIGS. 15 and 16) to form a sparse matrix or core 13 having a plurality of open spaces OS to form an “airy” core of predetermined thickness, referred to herein as “shred core”. Due to the number of open spaces OS, the panel has a relatively low density and weight. For example, the density is preferably less than 100 lbs/msf, more preferably less than 80 lbs/msf, and most preferably from about 30 lbs/msf to 60 lbs/msf. One or more liners 15 and 16 may be applied to opposite sides of the core, if desired or necessary. Within limits, the web or panel may be made in any desired thickness by applying the necessary thickness of bonded paper shreds and adding one or more liners.

A first process for producing the web or panel 11 is depicted in FIGS. 2 and 5. In this process, the paper shreds 12 are obtained by passing dry recovered paper of almost any sort, but with lightweight currently unused paper being preferred, through a simple separation apparatus 20 (FIG. 5) to remove large metallic or plastic inclusions. Using mechanical equipment 21 and operating in the dry state the paper is “sliced” or shredded to produce small “shreds” or pieces of paper. The pieces are passed through an air levitation chamber 22 so they are suspended at low concentration, and a suitable adhesive 23 is introduced into the chamber in aerosol or small particle form so that a very small but appropriate amount is applied to each piece of paper. Examples of adhesives or bonding agents could include wax, starch, hot melts, or materials that can be activated by microwaves, infrared, electron-beam, etc. Using a non-blocking, recyclable adhesive that is introduced in an inactive state is preferred. One possibility is a heat-sealing adhesive sprayed on the shreds and dried in the levitated state. Further, in a preferred embodiment magnetic particles or microwave susceptors (not shown) are interspersed in the adhesive. These particles or susceptors can then be activated with induction or microwave energy, respectively, in the combining section to form the required bonds. Once dried, the chips can be stored in a suitable container 24 for later use.

If the paper pieces or shreds have been pre-treated with an adhesive laden with magnetic particles for subsequent bond inducement by induction energy, the particles in the web may be controlled using magnetic fields. For instance, redistribution of the particles for more uniformity or a more desirable distribution may be possible using an alternating or controlled magnetic field. It may also be possible to induce a charge on the particles and control them with an electric field as in an electrostatic precipitator.

Further, the bonding agent and particles may be microencapsulated (not shown) for subsequent activation downstream in the process. Suitable technology is known in the prior art (see U.S. Pat. No. 6,375,872, for example) for attaching the capsules to the paper pieces or shreds so they remain in place and are properly distributed in the matrix.

The new paperboard product is then dry-formed to a desired thickness by depositing a layer or layers 25 of the dry coated shreds on a bottom liner 26 (see FIG. 2), with the shreds disposed in a three dimensional, sparse, and randomly oriented relationship. The shreds are supplied from a hopper 27 through one or more slots 28. A second liner 29 is then added on top of the deposited layer or layers. This sandwich then passes through a nip (not shown) to set the desired thickness, and thence between belts, e.g., 30, or an air bearing provided by, e.g., air box 31, to hold the thickness. Suitable energy applied in the compression section 32, e.g., induction energy from induction source 33, heats the coatings to the bonding point to cause the shreds of paper to be bonded to each other and to the liners. All of the induction heating will be concentrated in the adhesive so there will be very little heating of the shreds or liners. Consequently, the hot coatings cool quickly to form fiber-tearing bonds in the matrix. The resulting board or web 11 will be cool and dry when it leaves the machine, as opposed to hot and moist in the current process. Hence, it can be converted immediately with little or no loss of performance. The manufacturing system is small and can be operated at room temperature.

As shown in FIGS. 15 and 16, the randomly oriented pieces of paper 12 are bonded together only at crossing points CP to form a sparse matrix or core 13 having a plurality of open spaces OS to form an open “airy” core of predetermined thickness. Thickness of the core can be determined by platens 90 and 91, and setting of the adhesive can be achieved by use of induction coils 100.

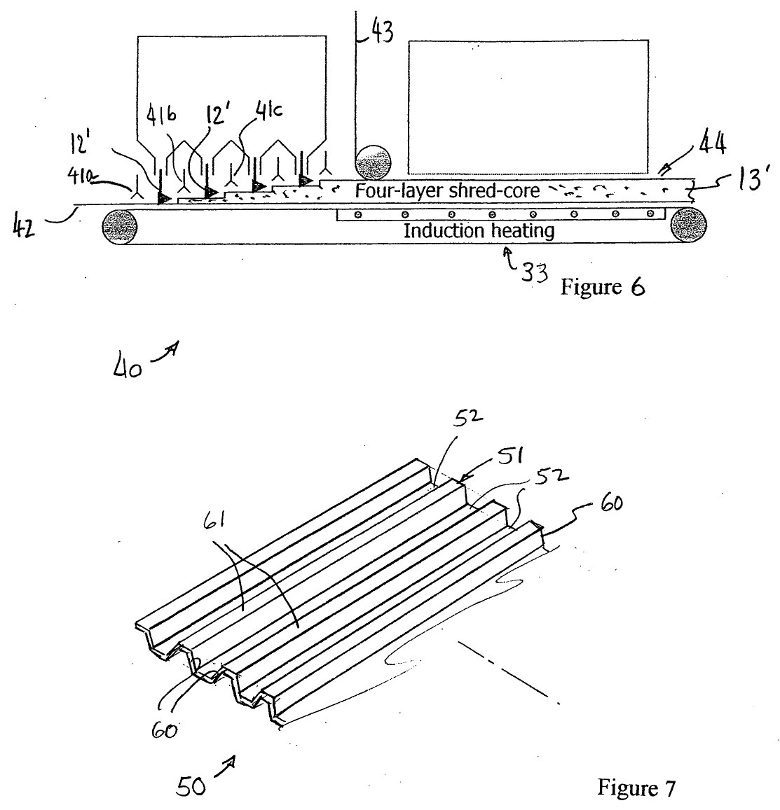

An alternative way to form a flat web or panel according to the invention is indicated generally at 40 in FIG. 6. In this form of the invention, the paper shreds 12′ are obtained generally as described above in connection with the first form of the invention, except that the shreds are not pre-coated with a thin layer of adhesive. In this form of the invention, a thin spray of adhesive 41a is first applied to a bottom liner 42, and a thin layer of dry, uncoated shreds 12′ is then laid down on the adhesive-coated liner. A second thin spray of adhesive 41b is applied on top of the layer of shreds, followed by a second layer of shreds to which a further spray of adhesive 41c is applied, and so on, until a core 13′ of desired thickness is achieved. The adhesive preferably contains a dispersion of very small magnetic particles (not shown) that can be heated by induction. After the last spray of adhesive is added, a top liner 43 is applied to form a sandwich of the shreds and liners. The sandwich then passes between rollers (not shown) with a fixed gap to set the caliper of the final structure. A final section 44 holds the caliper and applies induction energy from induction energy source 33 to “set” the adhesive to form a rigid structure. With water-based adhesives it will be necessary to “dry” the resulting structure to form a final product. This process is more energy intensive than the process using heat-sealing coatings, but may enable the use of less costly adhesives. One starch-based material, disclosed in U.S. Pat. Nos. 5,609,711 and 5,895,545, for example, may be used as an alternate bonding agent that has the potential to behave like hot-melt materials, but would not require drying in the induction section. Use of typical hot-melt adhesives laden with magnetic particles is also possible. Hot melts that can be sprayed are readily available, including “Glu Guru”®, available from Manufacturer's Supply Co., U1125.

2. Three-Dimensional Shaped Board:

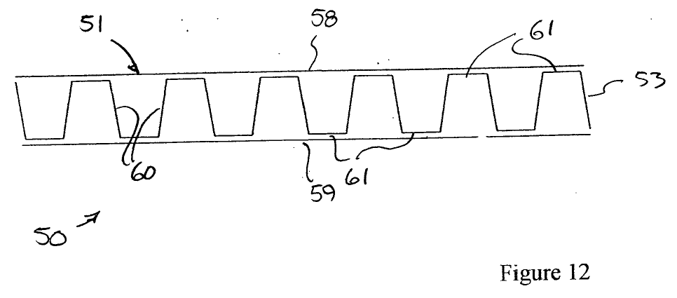

A panel or board made in accordance with a second aspect of the invention can be three-dimensional, i.e., have a shaped configuration other than flat as in the form of the invention described above. As indicated generally at 50 in FIGS. 7-13, a shaped three-dimensional structure 51 and a way of making it are shown. The particular shape shown in FIGS. 7 and 12 comprises a grooved structure with flat lands or caps that could replace the fluted medium used in corrugated shipping containers, for example. In one configuration, shown in FIG. 7, the panel 51 has grooves 52 that can be positioned parallel or perpendicular to the machine direction (shown perpendicular in this figure). The parallel orientation may be more difficult to manufacture and require more machinery changes, but it will provide superior performance in some aspects of the finished product.

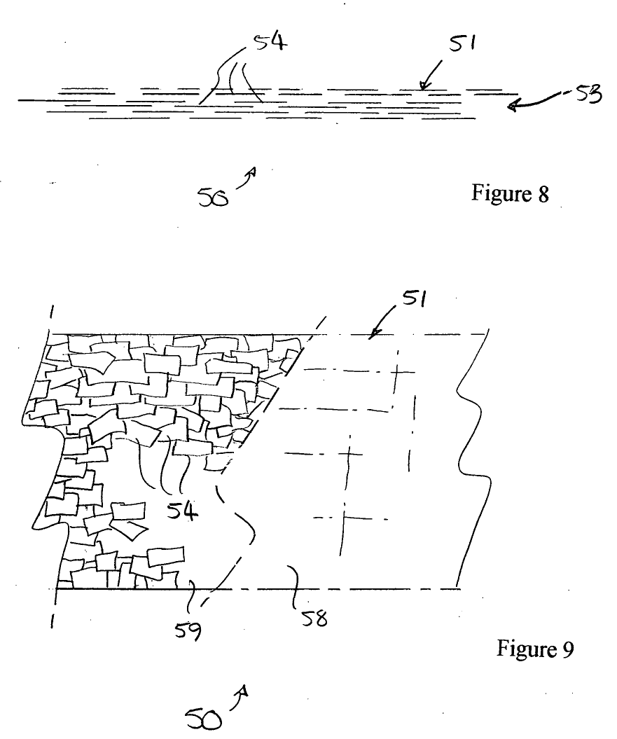

To make the panel 51, a relatively dense matrix or core 53 is made up of overlapped pieces of paper 54, seen in FIGS. 8, 9 and 11. The pieces of paper are obtained by passing recovered paper of almost any sort, but with lightweight currently unused paper being preferred, through a simple separation apparatus 20 in the dry state to remove large metallic or plastic inclusions. Using mechanical equipment 21′ and operating in the dry state the paper is “sliced” or comminuted to produce fairly large (preferably 50-100 mm) flat pieces or “chips” of paper. In the particular example shown, the pieces are passed through an air levitation chamber 22 to suspend them at low concentration, and a suitable adhesive 23 is introduced into the chamber in aerosol or small particle form so that a very small but appropriate amount is applied to each strip or piece of paper. Examples of adhesives or bonding agents could include wax, starch, hot melts, or materials that can be activated by microwaves, infrared, electron-beam, etc. Using an adhesive that is introduced in an inactive state is preferred. One possibility is a heat-sealing adhesive sprayed on the paper “chips” and dried in the levitated state. Further, in a preferred embodiment magnetic particles or other energy susceptors are interspersed in the adhesive. These particles or susceptors can then be activated with induction or other energy form, respectively, in the combining section to form the required bonds.

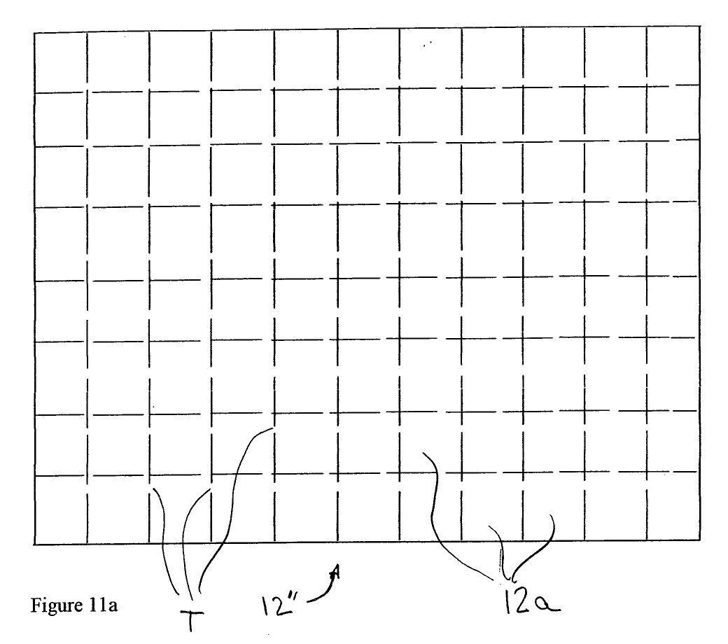

Alternatively, the large clean pieces of paper leaving equipment 21′ may be partially slit into smaller segments 12a that remain intact within the larger sheet 12″ because of small remaining connective tabs T (FIG. 11a). Adhesive is applied in a sparse geometric pattern to cover perhaps 10% of the total area. These large pieces 12″ are then formed into a multiple layer loose web. As the large pieces pass through the forming apparatus the remaining connective tabs T within the large pieces are broken by the forming stresses to form the many smaller pieces 12a most desirable for the finished product. Using these two approaches, semi-slitting and partial gluing reduces the cost of adhesives, and comminution and adhesive setting energy, and makes the paper handling process much easier.

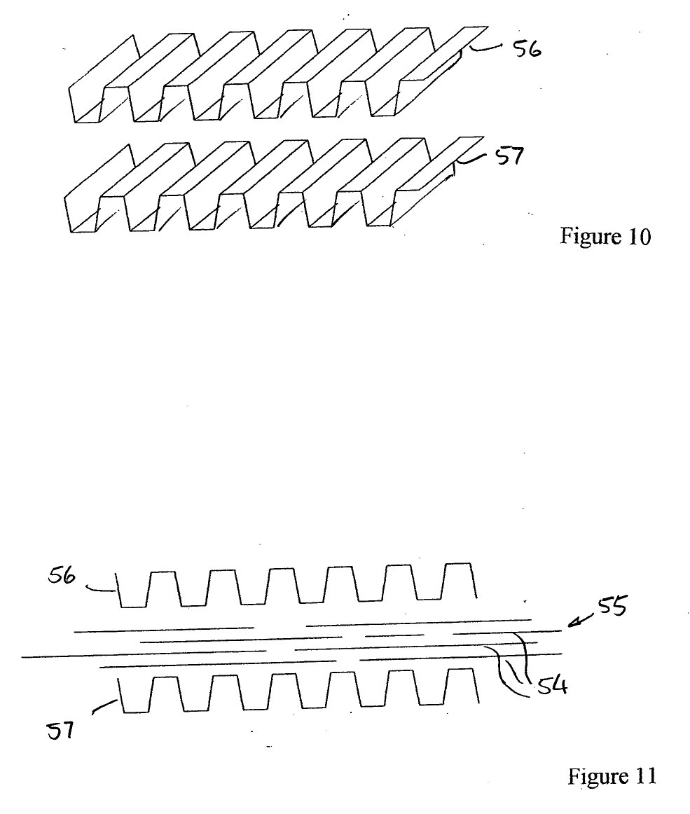

As the pre-glued dry mixture passes out of the levitation chamber it is formed into a continuous un-bonded or loosely bonded web 55 (see FIGS. 8 and 9) with a thickness of a few overlapping loose pieces, perhaps 2-10 layers. Still in this loose or semi-bonded state the “web” is placed between a pair of plates or rollers 56 and 57 (see FIGS. 10 and 11). Each plate or roller has a desired shape, e.g., grooved in the example shown, to produce the desired article configuration, e.g., a grooved shape.

As the “web” is compressed between these elements, the pieces of paper 54 slide over each other to conform to the shape of the plates or rollers, i.e., the grooves shown. When this form is achieved, energy is applied to activate the adhesive between the strips to form a solid, rigid laminated structure with the shape of the grooves. The plates or rollers can be arranged so the grooves run in the machine direction, i.e. along the machine, or in the machine cross direction.

In a second step, continuing support is provided on only one side of the web or panel 51 by one, e.g., 56, of the grooved plates or rollers. A liner 58 is then brought into contact with the unsupported side of the grooved web and bonded in place. Bonding may be achieved by conventional means using starch adhesives, as in conventional corrugating, or by using the heat-sealing or other bonding material still present on the exposed tips of the grooved structure. A second liner 59 is then added to the opposite side of the panel by using the same bonding approach or in a more-or-less conventional manner. The resulting structure, shown in FIG. 12, is similar to conventional corrugated except for several significant differences, as follows. The liners may be applied in either the machine direction or the cross direction, although orientation of the flutes and liners in the cross direction is preferred. The side walls or legs 60 of the flutes may be at an optimum angle to the attached liners, leading to a much higher z-direction stiffness and crush resistance than for a conventional fluted shape. In this regard, the angle of the legs of the flutes is determined by the length and height of the flutes. The wavelength and height of the flutes in the invention can be longer than in conventional corrugated material. This will improve the overall performance of the box and still reduce damage in the ensuing converting operations, so costly in conventional corrugating. The structure will give the inherently higher stiffness and strength of a laminated structure, further improving the performance of the core and, therefore, of the box structure. The flat tops 61 of the grooved structure bonded to the liner reinforce extensional stiffness and provide much more support for the liners 58 and 59 to reduce liner buckling between the ridges, a factor that will further improve performance, especially with respect to accelerated creep in cycling humidity environments, typical of the distribution system in which boxes are used.

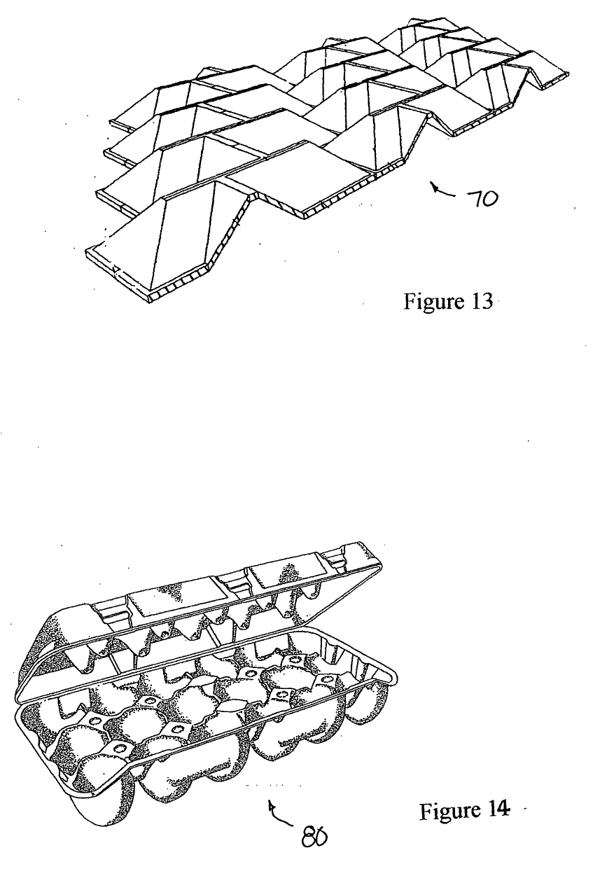

Other three-dimensional shapes can also be produced with the invention. Examples include trussboard, an example of which is shown at 70 in FIG. 13, and egg cartons such as shown at 80 in FIG. 14. Trussboard is conventionally made in a press from a dilute slurry of fiber. In accordance with the invention, a thin web of shreds, perhaps weakly bonded, could be passed through a press with surfaces that generate the geometry shown in FIG. 13, or similar geometry. The shreds would then be fully bonded together to form a rigid structure. Egg cartons are conventionally made as a molded pulp product. By using the invention, pre-glued shreds would be passed through a press with suitable forming dies to shape the product and bond the shreds together to provide rigidity. These are but two examples of myriad three-dimensional shapes that could be made with the invention.

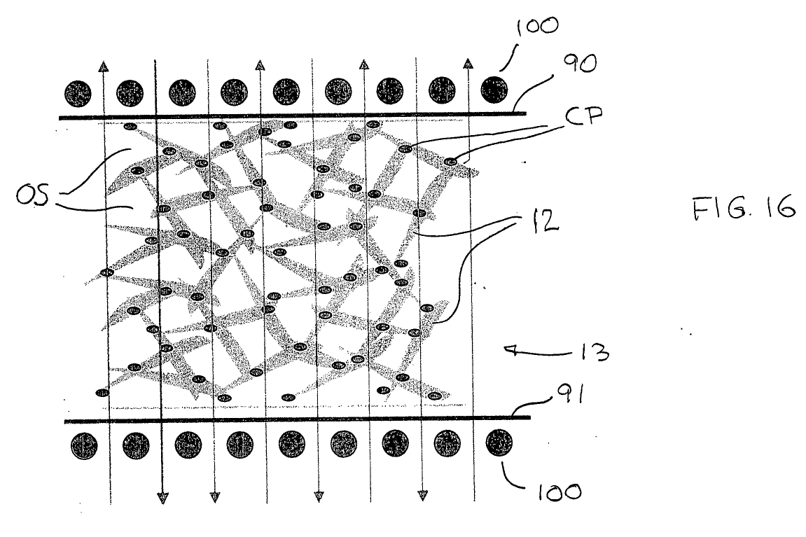

The invention can be used to produce a liner L for application to the core, as shown in FIG. 17, or a very thin veneer V to which can be applied a conventional liner L′ to hide any graphics that may be present on the recycled paper used in the manufacture of the liner L, as shown in FIG. 18. This would entirely eliminate the conventional inside liner on the box and yield a substantial additional cost advantage.

Although not shown in the drawings, compression of the loose web can also be achieved by passing the web between belts that contain properly oriented closed circuit conductors and whose surface has the desired shape. In one part of the compression section current can be induced in the conductors by using an appropriate magnetic field. As these current-carrying conductors pass through the balance of the compression section, another magnetic field is imposed to generate a Lorentz force perpendicular to the belt. Increasing the force slowly over the length of the compression section could provide the environment necessary for the paper chips to slide over one another and form a uniform web without built-in pre-stresses. After the web is formed in this section it can be held for transport to the next processing station by using vacuum or an attracting magnetic field (in those embodiments where magnetic particles are present in the bonding agent).

Although particular embodiments of the invention are illustrated and described in detail herein, it is to be understood that various changes and modifications may be made to the invention without departing from the spirit and intent of the invention as defined by the scope of the appended claims.

What is claimed is:

1. A rigid unitary panel made from paper products, comprising:
at least one layer of small pieces of paper bonded together to form said panel.

2. A panel as claimed in claim 1, wherein:
the panel is substantially flat.

3. A panel as claimed in claim 1, wherein:
the panel has a three-dimensional shape.

4. A panel as claimed in claim 3, wherein:
the three-dimensional shape defines a plurality of elongate parallel flutes and grooves extending across the panel.

5. A panel as claimed in claim 4, wherein:
the flutes have a rectilinear configuration in transverse cross-section, with straight sidewalls and a flat top wall extending substantially parallel to the plane of the panel.

6. A panel as claimed in claim 1, wherein:
at least one paper liner is bonded to at least one side of the panel.

7. A panel as claimed in claim 1, wherein:
a paper liner is bonded to top and bottom surfaces of the panel.

8. A panel as claimed in claim 3, wherein:
at least one paper liner is bonded to at least one side of the panel.

9. A panel as claimed in claim 4, wherein:
a paper liner is bonded to top and bottom surfaces of the panel.

10. A panel as claimed in claim 5, wherein:
a paper liner is bonded to the flat top walls of the flutes in spanning relationship to the grooves.

11. A panel as claimed in claim 1, wherein:
the pieces of paper are randomly oriented in three dimensions in the core and are bonded together only at crossing points to form a light airy panel of predetermined thickness.

12. A liner for application to a paperboard core used in the manufacture of boxes and the like, comprising:
at least one layer of small pieces of paper bonded together to form a sheet of material usable as a liner in the manufacture of paperboard products.

13. A process for forming a paper product, comprising the steps of:
shredding or cutting paper to obtain small pieces of paper;
depositing the pieces of paper onto a support to form a core layer;
applying a bonding agent to the pieces of paper either before or after they are deposited onto the support; and
bonding the pieces of paper together by subjecting the core layer to a source of energy to activate or set the bonding agent to form a rigid unitary product

14. A process as claimed in claim 13, wherein:
the bonding agent is applied to the pieces of paper prior to depositing them onto the support.

15. A process as claimed in claim 13, wherein:
the bonding agent is applied to the pieces of paper after they are deposited onto the support.

16. A process as claimed in claim 13, including the step of:
compressing the core layer to a predetermined thickness and density.

17. A process as claimed in claim 13, wherein:
the process is performed while the pieces of paper are in a dry state.

18. A process as claimed in claim 17, wherein:
the support comprises a bottom paper liner, and said liner is bonded to the core layer.

19. A process as claimed in claim 18, including the step of:
adding a top paper liner to the core layer.

20. A process as claimed in claim 16, wherein:
the compressing step imparts a three-dimensional shape to the product.

21. A process as claimed in claim 13, including the steps of:
levitating the pieces of paper in a dispersed dry state; and
applying the bonding agent to the pieces of paper while they are levitated.

22. A process as claimed in claim 20, wherein:
the three-dimensional shape comprises a plurality of elongate, parallel flutes or ridges and grooves extending across the core layer.

23. A process for forming a paper product as claimed in 13, including the steps of:
mixing small particles of magnetic susceptors in the bonding agent; and
applying magnetic or static electric energy to the bonding agent during manufacture of the paper product to manipulate the pieces during formation of the product.

24. A process as claimed in claim 13, wherein:
the pieces of paper are obtained from recycled or recovered paper.

25. A process as claimed in claim 23, wherein:
the pieces of paper are obtained from recycled or recovered paper.

26. A process as claimed in claim 13, including the step of:
encapsulating the bonding agent in microcapsules to control the amount, delivery, and distribution of the bonding agent.

27. A process as claimed in claim 13, wherein:
the paper product comprises a liner and a core; and
the pieces of paper are oriented in the liner and core so as to permit constructions using liner to core combinations of CD/CD, CD/MD, MD/MD, and MD/CD, wherein CD is machine cross direction and MD is machine direction

28. A process as claimed in claim 13, wherein:
the pieces of paper forming the core layer are tack-bonded together for easier manipulation during a forming step to form the core layer into the paper product.

29. A process for forming a rigid, unitary panel product, comprising the steps of:
shredding or cutting a material including paper or plastic to obtain small pieces of the material;
mixing the pieces of material with a bonding agent to form a sparse matrix defining a web of the pieces of material and unbonded bonding agent;
forming the web into a desired shape; and
activating or setting the bonding agent to bond the pieces of material together and form the rigid, unitary panel product.

30. A process as claimed in claim 29, wherein:
the bonding agent is susceptible to an induced magnetic field or other form of energy to set the bonding agent to bond the pieces of material together.

31. A process as claimed in claim 29, wherein:
the bonding agent is a foamed adhesive.

32. A process for making a shaped, rigid, unitary panel product, comprising the steps of:
shredding or cutting paper to obtain small pieces of the paper;
depositing the pieces of paper onto a support to form an unbonded web comprising the pieces of paper and a bonding agent;
shaping the unbonded web to form a panel having a desired shape; and
activating the bonding agent to bond the pieces of paper together to form a rigid product from the shaped panel.
